(19) United States
(12) Patent Application Publication
(10) Pub. No.: US 2003/0093911 A1
(43) Pub. Date: May 22, 2003

(54) Compact disk titling stencil

(76) Inventor: Stephen John Roman, Morris Plains, NJ (US)

Correspondence Address: Stephen J. Roman, Jr., M.D., 4 Spencer Court, Morris Plains, NJ, 07950, US

(21) Appl. No.: 10/237,950

(22) Filed: Sep. 9, 2002

Related U.S. Application Data
(60) Provisional application No. 60/285,956, filed on Sep. 12, 2001.

(51) Int. Cl. B43L 7/00

(52) U.S. Cl. 33/566

(57) ABSTRACT

Compact disk titling stencil fits onto the surface of a compact disk for the drawing of lines for easy labeling.

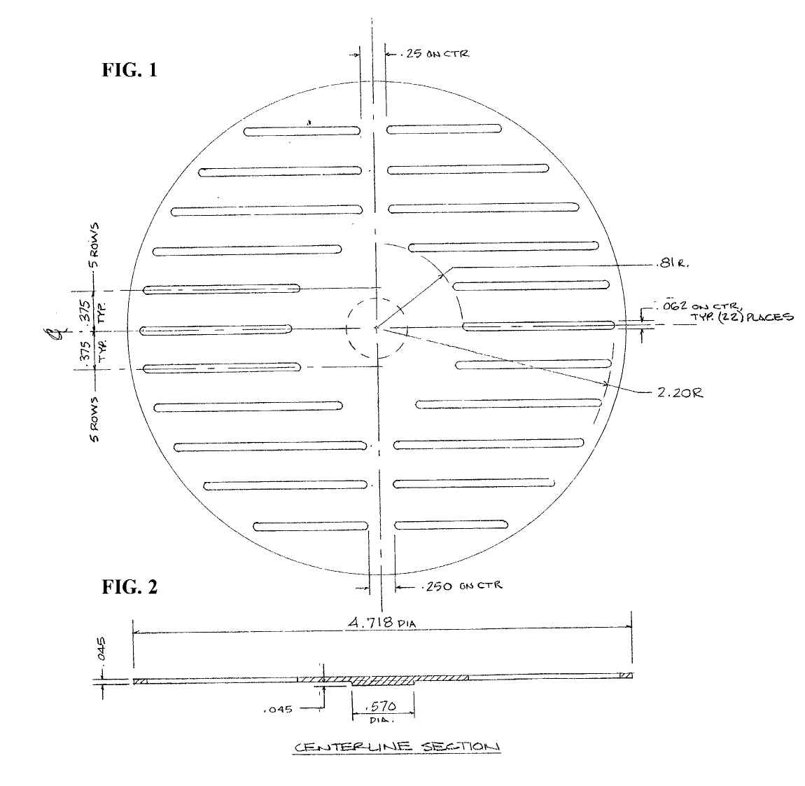

### DETAILED DESCRIPTION OF THE INVENTION

This is a disk made of plastic which fits over the hole in the center of a compact disk, aligning it properly for one to draw lines onto a compact disk for labeling.

To use this device, one requires a compact disk and a writing utensil.

Use of the device involves placing it over a compact disk and aligning the raised surface with the hole in the center of the compact disk, then drawing lines on the disk, through the holes in the device with a writing utensil.

The device can be manufactured by plastic injection molding.

What makes this device unique from other stenciling devices, is that it fits into the hole in the center of a compact disk and over the surface of a compact disk for the drawing of lines of proper size and location for easy labeling.

1. What I claim as my invention is a device which fits into the hole of a compact disk and over the surface of a compact disk, with holes allowing one to draw lines of the proper size and location for the purpose of labeling the disk.
